(19) United States
(12) Patent Application Publication
(10) Pub. No.: US 2013/0142201 A1
(43) Pub. Date: Jun. 6, 2013

(54) CONNECTING ON-PREMISE NETWORKS WITH PUBLIC CLOUDS

(71) Applicant: Microsoft Corporation, Redmond, WA (US)

(72) Inventors: Changhoon Kim, Redmond, WA (US); Vijayan Ramakrishnan, Bellevue, WA (US); Albert Greenberg, Redmond, WA (US); Monika Machado, Sammamish, WA (US); Vijay P. Singh Gill, Hunts Point, WA (US); Dharshan Rangegowda, Redmond, WA (US)

(73) Assignee: MICROSOFT CORPORATION, Redmond, WA (US)

(21) Appl. No.: 13/650,750

(22) Filed: Oct. 12, 2012

Related U.S. Application Data
(60) Provisional application No. 61/566,166, filed on Dec. 2, 2011.

(51) Int. Cl. H04L 12/56

(52) U.S. Cl. 370/392

(57) ABSTRACT

A computer system for encapsulating a packet between a customer premise for delivery to customer resources within a public cloud data center. The computer system comprises a shim gateway. The shim gateway comprises a plurality of customer specific shim components. The shim gateway is configured to receive a packet from a customer premise. The packet has a VLAN tag. The packet identifies a tenant within a designated virtual network for the customer. The designated virtual network is within the public cloud data center. The shim gateway is further configured to encapsulate the packet into an encapsulated packet. Encapsulation includes mapping the VLAN tag to a destination network address of a tenant gateway for the customer. The tenant gateway is in the designated virtual network. The shim gateway is further configured to forward the encapsulated packet to the tenant gateway in the designated virtual network for delivery to the identified tenant.

### CROSS-REFERENCE TO RELATED APPLICATIONS

This application claims the benefit of U.S. Provisional application 61/566,166 filed Dec. 2, 2011, titled “CONNECTING ON-PREMISE NETWORKS WITH PUBLIC CLOUDS”, which is incorporated herein by reference in its entirety.

### BACKGROUND

### Background and Relevant Art

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data. Accordingly, the performance of many computing tasks is distributed across a number of different computer systems and/or a number of different computing environments.

In some computing environments, an entity (e.g., a corporation) builds out an infrastructure and runs applications, such as, for example, Web services, “on-premise” within the infrastructure. In these computing environments, computing tasks are performed on the on-premise (or private) computer network. For example, a corporation (or other enterprise customer) can have a computer network formed from resources under its ownership and control. The corporation (or other enterprise customer) can make a private network available to its employees to perform networked computing tasks.

In other computing environments, one entity uses another entity's infrastructure to run application on behalf of the entity. For example, one entity can run an application on machines in another entities data center. Running an application in another entities data center can be referred to as running an application “in the cloud”. When applications are run in the cloud, computing resources and storage resources of the data center are allocated to a user.

In some computing environments, work is performed using both on-premise and cloud resources. In these “hybrid” arrangements, on-premise resources and cloud resources can interoperate to assist in solving a common problem. Hybrid arrangements can exist on a temporary basis, such as, for example, when one entity supplements its own resources with resources from another entity. For example, when on-premise resources are operating at or near capacity or in response to a surge in workload, a user of the on-premise resources can request allocation of cloud resources to perform additional work. When the additional work is completed, the cloud resources can be returned back to an available pool of resources for allocation to other users. The user can be charged for use of any allocated resources. Thus, the user of the on-premise resources essentially rents cloud-based resources.

Outsourcing computing workloads to a public cloud, can require significant bandwidth between a user's on-premise network and the public cloud. To reach a public cloud, data from an on-premise network typically passes through a gateway between the on-premise network and the network of the cloud provider. However, existing gateway solutions for realizing this cross-premise connectivity fail to meet various requirements, such as, for example, increased performance, multi-tenancy, security, predictability, compatibility with various modes of access, scalability, low cost, and simplicity.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment illustrated herein is directed to a method practiced at a computer system including one or more processors and system memory. The computer system includes a shim gateway. The method includes acts for encapsulating a packet between a customer premise for delivery to customer resources within a public cloud data center. The method includes an act of receiving a packet from a customer premise. The packet is received at a customer specific shim component in the shim gateway. The packet has a VLAN tag. The packet identifies a tenant within a designated virtual network for the customer. The designated virtual network is within the public cloud data center. The method further includes an act of encapsulating the packet into an encapsulated packet. Encapsulation includes mapping the VLAN tag to a destination network address of a tenant gateway for the customer. The tenant gateway is in the designated virtual network. The method further includes an act of forwarding the encapsulated packet to the tenant gateway in the designated virtual network for delivery to the identified tenant.

Another embodiment illustrated herein includes a method that may be practiced at a computer system including one or more processors and system memory. The computer system includes a tenant gateway. The method includes acts for delivery of an encapsulated packet between a customer premise for delivery to customer resources within a public cloud data center. The method includes an act of the tenant gateway receiving an encapsulated packet for delivery to a tenant in a designated virtual network. The encapsulated packet is sent to the tenant gateway from a shim gateway component for the customer using a destination network address for the tenant gateway that was mapped from a VLAN tag. The method further includes an act of the tenant gateway using information in the encapsulated packet to send data from the encapsulated packet to the tenant in the designated virtual network.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates generally a number of modalities for communicating packets from a customer premise to a data center;

FIG. 2 illustrates communication details of a tenant gateway;

FIG. 3 illustrates an indirect splicing example of communication between customer premises and a data center;

FIG. 4 illustrates a second example of indirect splicing for communication between customer premises and a data center;

FIG. 5 illustrates shim device operations for indirect splicing;

FIG. 6 illustrates a direct splicing example of communication between customer premises and a data center;

FIG. 7 illustrates shim device operations for direct splicing;

FIG. 8 illustrates a detailed example of direct splicing;

FIG. 9 illustrates a detailed example of ISP/MPLS Attachment;

FIG. 10 illustrates packet flow from a customer premise to a data center for a direct connect example;

FIG. 11 illustrates packet flow from a data center to a customer premise for a direct connect example;

FIG. 12 illustrates a first redundancy model;

FIG. 13 illustrates a second redundancy model;

FIG. 14 illustrates a third redundancy model;

FIG. 15 illustrates a method of encapsulating a packet between a customer premise for delivery to customer resources within a public cloud data center; and

FIG. 16 illustrates a method of encapsulating a packet between a customer premise for delivery to customer resources within a public cloud data center.

### DETAILED DESCRIPTION

The present invention extends to methods, systems, and computer program products for connecting on-premise networks with public clouds. Embodiments of the invention include a cross-premise gateway configured for a public cloud offering. The gateway facilitates cross-premise connectivity between a customer's on-premise networks and a public cloud. The gateway supports scalability, multiple modes of access, multi-tenancy, simplicity, and support for virtualization protocols, such as, for example, Network Virtualization using Generic Routing Encapsulation (“NVGRE”). Accordingly, customers are provided efficient and predictable (e.g., better Service Level Agreements (“SLAs”)) cross-premise connectivity to utilize a public cloud.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, edge devices, gateways, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

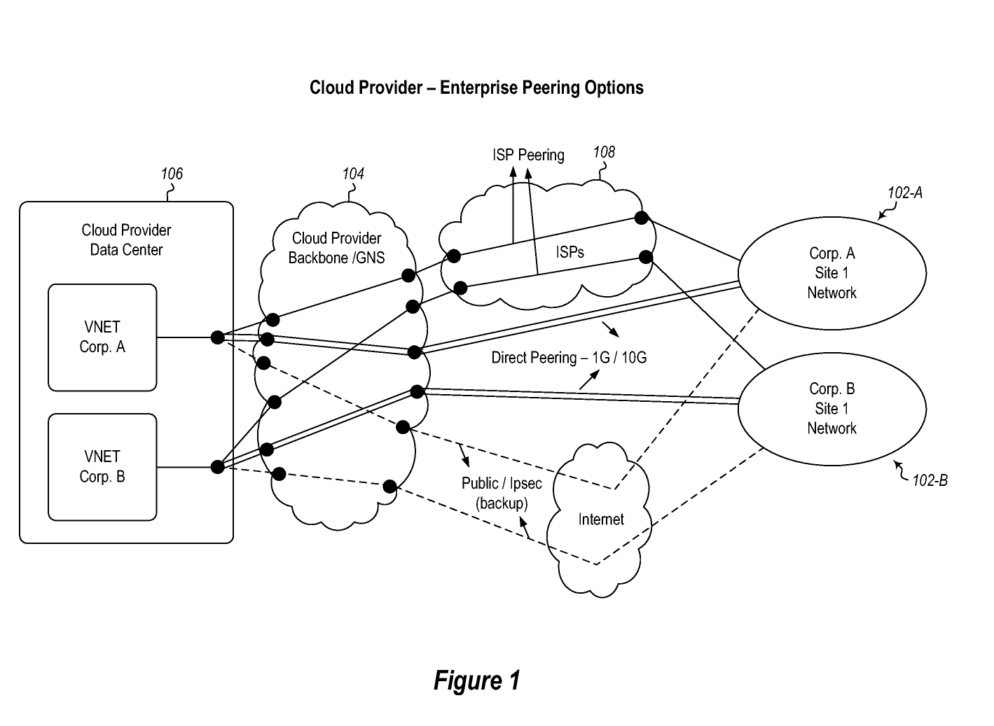

Referring now to FIG. 1, embodiments of the invention can use various different dedicated access connectivity options, including direct peering. FIG. 1 illustrates direct peering where corporate networks 102-A and 102-B, through their enterprise gateways connect directly to a cloud provider backbone/Global Network Service (“GNS”) 104, using Global Network Service Peer points, to a cloud provider data center 106. Alternatively, embodiments of the invention can use dedicated access connectivity options including Internet Service Provider (“ISP”) peering. As illustrated in FIG. 1, corporate networks 102-A and 102-B using their enterprise gateways, can connect to an Internet Service Provider 108, to a cloud provider backbone/Global Network Service (“GNS”) 104, and to a cloud provider data center 106.

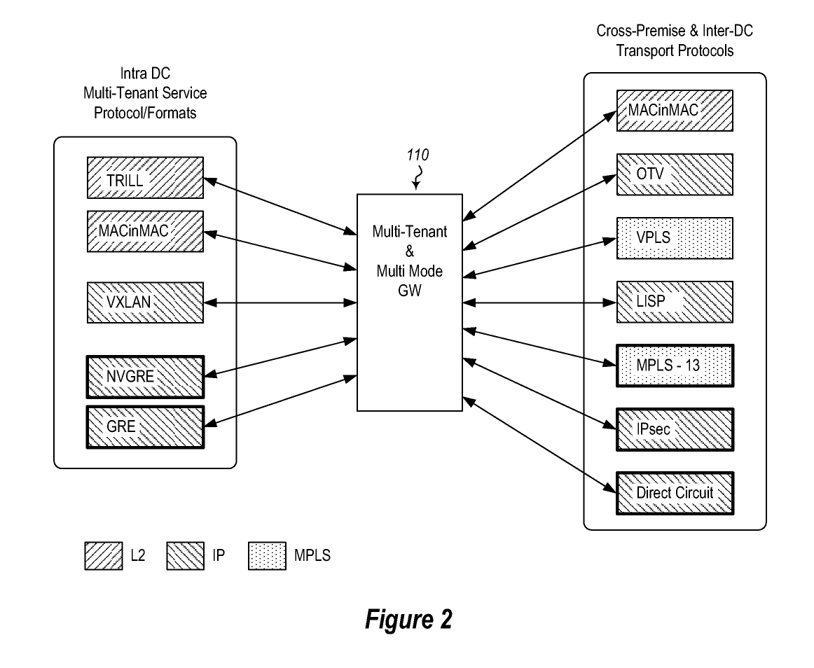

A gateway can be physically located at an anchor site for an ISP or Dedicated Connection Provider. Logically, the gateway can provide multi-tenant and multi-mode access functionality. FIG. 2 depicts an example gateway 110 illustrating logical representation of gateway functionality. However, various different components of a gateway can be utilized to provide gateway functionality. For example, gateway functionality can be split between different components and/or locations.

Generally, a multi-tenant multi-mode gateway can provide high bandwidth (e.g., 200 GB/s+ per data center) at a reduced cost. A gateway can provide multi-protocol cross premise connectivity (e.g., via dedicated access or ISPs) using Multiprotocol Label Switching (“MPLS”) (e.g., L3vpn, 6PE, 6VPE, etc), Ethernet over MPLS (EoMPLS), Virtual Private LAN Services (“VPLS”), Locator/ID Separator Protocol (LISP), Generic Routing Encapsulation (GRE), Level 2 Tunneling Protocol version 3 (L2TPv3), Direct circuit handoff, etc. A gateway can provide logical/virtualized multi-tenancy support.

A gateway can provide dynamic routing. For example this may be done with Border Gateway Protocol (“BGP”)/Extensible Messaging and Presence Protocol (“XMPP”) peering with tenant gateways. Gateway redundancy can be provided. For example, in some embodiments this may be provided via BGP multi-path/Equal-cost multi-path routing (“ECMP”).

A gateway can be programmable to create/delete loopbacks, GRE/NVGRE tunnel end points, VPN, BGP peering on router, etc. from the gateway to tenants. Standardized Interface/APIs and control protocols can assist with demand/automated provisioning.

As described, a gateway architecture can use a split model. For example, a gateway can be split into a front-end and a back-end. The front-end can be a shim gateway located at a remote anchor or peering site, for example, located afar from cloud-computing data centers. A shim gateway can be a commodity switch or appliance configured for tunnel encapsulation/decapsulation.

The back-end can be tenant gateway virtual machine(s) (VMs) at a cloud computing data center. Gateway tenant VMs can have different arrangements. In some embodiments, tenant gateway VMs serve a single Virtual Network (“VNet”) (a non multi-tenant arrangement). In other embodiments, tenant gateway VMs serve multiple VNets (a multi-tenant arrangement). In some embodiments, a shim gateway and tenant gateway virtual machines are commonly owned.

A gateway can provide Virtual Routing and Forwarding (VRF), VLANs to VNet translation layer using different mechanisms. In some embodiments, an indirect splicing mechanism uses Generic Routing Encapsulation (“GRE”) tunnels to Virtual Machines (“VMs”). In some embodiments, a direct splicing mechanism uses directory service lookup and VNet-NVGRE encapsulation/decapsulation. The direct mechanism also maps Tenant IDs in NVGRE to VRF instance and vice versa.

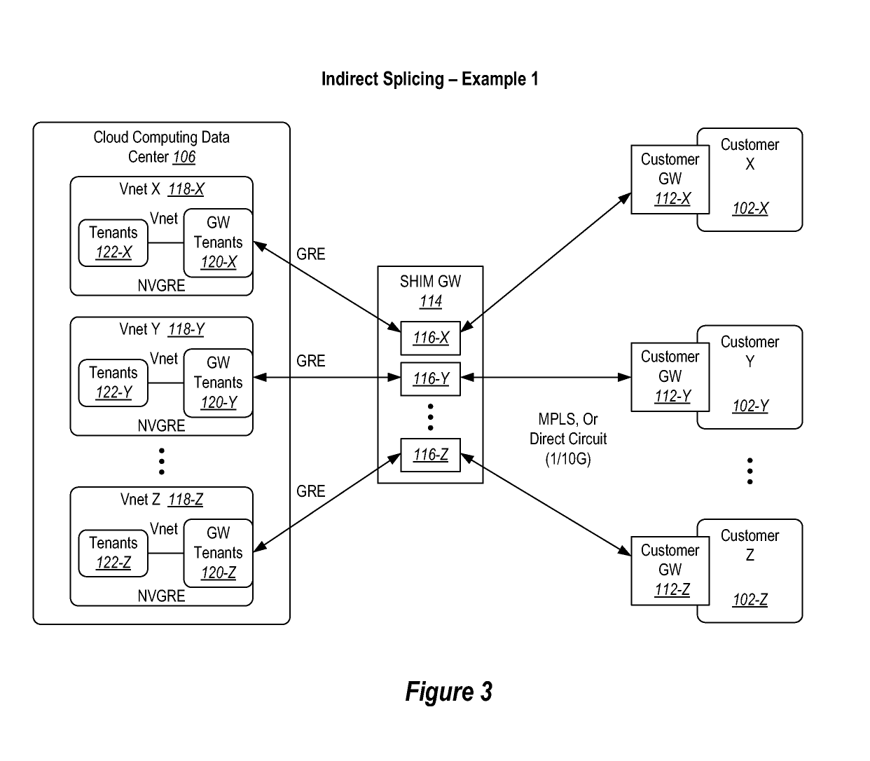

FIG. 3 depicts an example of indirect splicing. As depicted in FIG. 3, communication from any of a variety of customer networks, including customer networks 102-X , 102-Y and 102-Z is sent from customer premises via customer gateways 112-X, 112-Y, and 112-Z to a shim gateway 114 (i.e., front-end of a gateway 110). Data from customers can be sent using any of a variety of different protocols such as MPLS and direct circuit. The shim gateway 114 includes components 116-X, 116-Y, and 116-Z corresponding to each customer. For each customer, the corresponding component at the shim gateway 114 translates communication from the customer into GRE communication.

Shim components (referred to generally as 116) can be configured to send GRE communication to a specified VNet. For example, the shim component 116-X can be configured to forward communication from customer network 102-X to VNet 118-X. GRE communication is forwarded to the corresponding specified VNet (e.g., VNet 118-X, VNet 118-Y, VNet 118-Z, etc.).

At each VNet, corresponding tenant gateways 120-X, 120-Y and 120-Z receive GRE communication. The tenant gateways (referred to generically at 120) are examples of back-ends of the gateway 110. A tenant gateway 120 translates GRE communication into NVGRE communication. The GRE communication and NVGRE communication are examples of a data plane. The tenant gateway 120 can also use addressing information in the GRE communication to locate appropriate tenants (e.g. tenants 122-X, 122-Y, and 122-Z) in the VNet (referred to generically as 118) for receiving the customer data. This is an example of a control plane. An example of using addressing information includes a directory lookup based on IP addresses in the GRE communication. The customer data is then sent to the appropriate tenants (referred to generically as 122) using NVGRE.

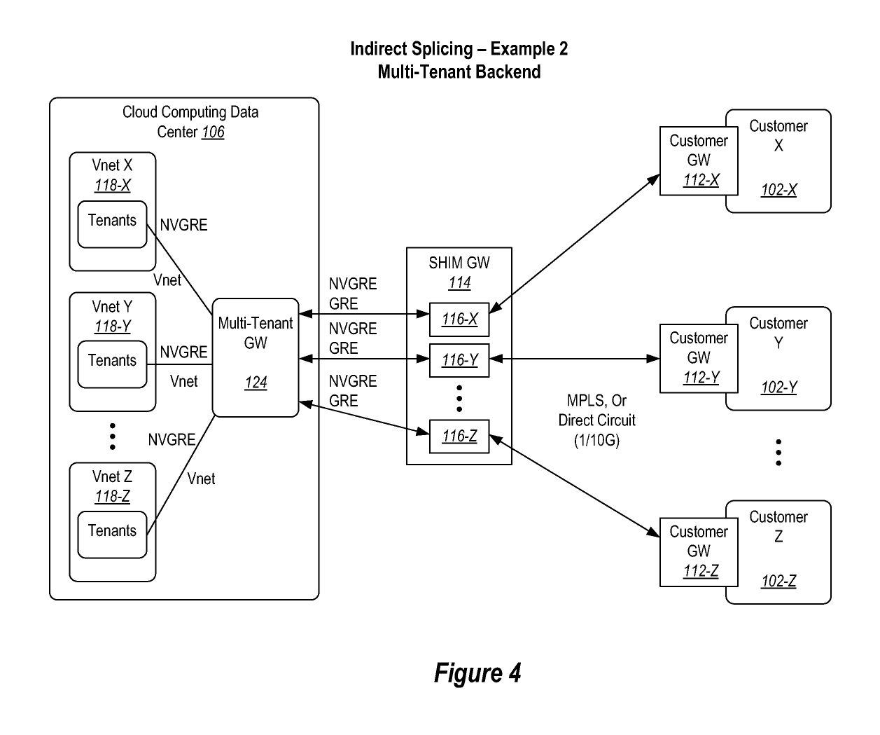

FIG. 4 depicts a second example of indirect splicing. Similar to FIG. 3, FIG. 4 depicts that communication from any of a variety of customers including customers X, Y and Z is sent from on-premise customer network 102-X, 102-Y and 102-Z via customer gateways 112-X, 112-Y and 112-Z to a shim gateway 114, that functions as a front-end of the gateway 110 illustrated in FIG. 2. Data from customers can be sent using any of a variety of different protocols such as MPLS and direct circuit. The shim gateway 114 includes a component 116-X, 116-Y and 116-Z corresponding to each customer X, Y and Z respectively. For each customer, the corresponding component at the shim gateway translates communication from the customer into NVGRE or GRE communication. GRE can be used between the shim gateway 114 and the multi-tenant gateway 124 (the multi-tenant gateway 124 is an example of a backend of the gateway 110 illustrated in FIG. 2) if multiple virtual IP addresses (VIPs) can be assigned to the multi-tenant gateway 124, each of which is unique for a VNet (e.g. VNets 118-X, 118-Y and 118-Z). If multiple VIPs are not used (either because they cannot be assigned or a choice is made not to use them) NVGRE is used along with one common VIP.

Shim components (referred to generically as 116) can be configured to send the NVGRE or GRE communication to the multi-tenant gateway 124, that in this example, is used as a back-end of the gateway 110. Accordingly, any of shim components 116-X, 116-Y and 116-Z that have customer data can send the customer data to the multi-tenant gateway 124.

When appropriate, the multi-tenant gateway 124 can translate GRE communication into NVGRE communication in the data plane. The multi-tenant gateway 124 can also use addressing information in the GRE or NVGRE communication to locate (e.g., a directory lookup based on IP addresses in the GRE or NVGRE communication) appropriate tenants within an appropriate VNet for receiving the customer data to implement a control plane. The customer data is then sent to the appropriate VNet and onto the appropriate tenants within the appropriate VNet using NVGRE.

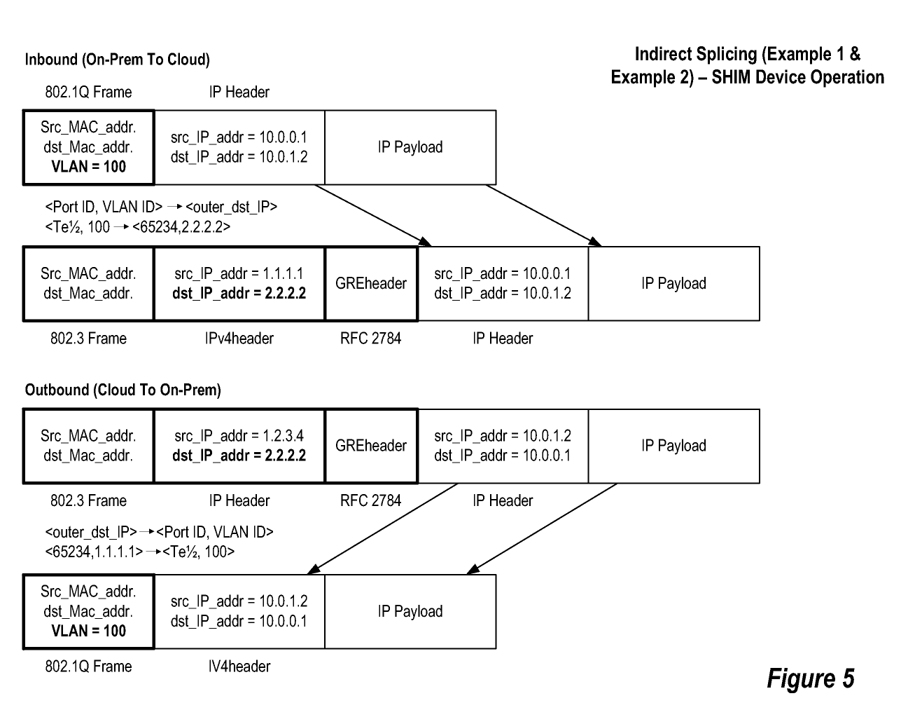

FIG. 5 depicts shim gateway 114 operation for indirect splicing. FIG. 5 depicts shim gateway 114 operation for GRE. In another example of indirect splicing, NVGRE can be used as well. When using NVGRE, the multi-tenant gateway 124 (see FIG. 4) uses a common public IP address to communicate with the shim gateway 114. As depicted in FIG. 5, for inbound communication a VLAN tag (VLAN=100) is mapped to a tenant gateway (outer) destination IP address (2.2.2.2). For outbound communication, the shim gateway (outer) destination IP address (1.1.1.1) is mapped to the VLAN tag (VLAN=100).

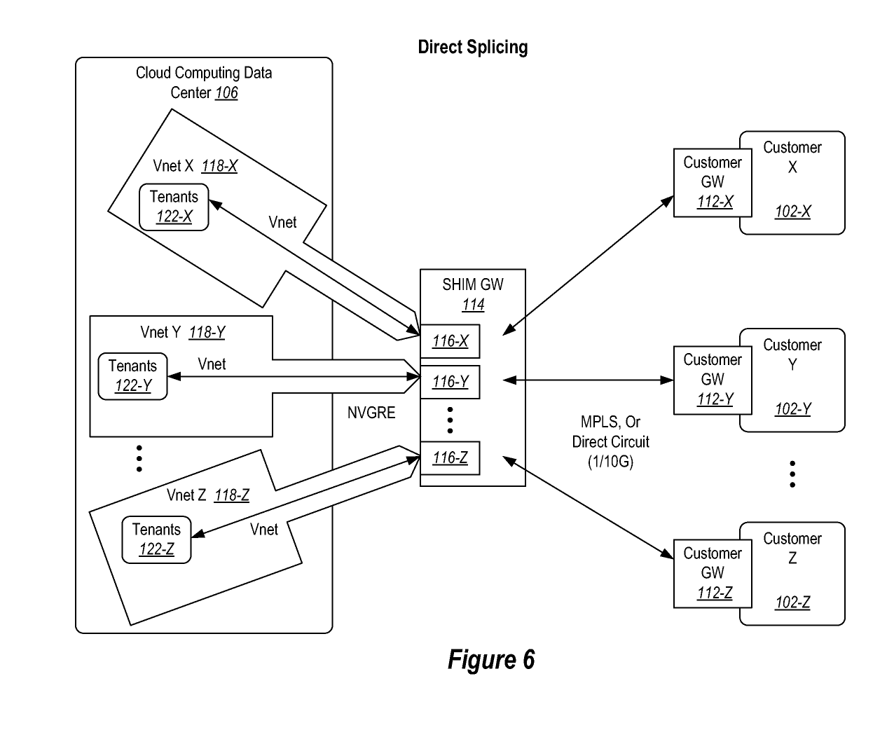

FIG. 6 depicts an example of direct splicing. As depicted in FIG. 6, communication from any of a variety of customers, including customers X, Y, and Z is sent from customer networks 102-X, 102-Y and 102-Z via customer gateways 112-X, 112-Y and 112-Z to a shim gateway 114 which functions as a front-end of the gateway 110. Data from customers can be sent using any of a variety of different protocols including MPLS and direct circuit. The shim gateway 114 includes a component 116-X, 116-Y and 116-Z corresponding to each customer. For each customer, the corresponding component at the shim gateway 114 translates communication from the customer into NVGRE communication.

Further, each shim component 116-X, 116-Y and 116-Z is compatible with a VNet (referred to generically as 118). Thus, the shim components 116-X, 116-Y and 116-Z can use addressing information in the NVGRE communication to locate (e.g., a directory lookup based on IP addresses in the NVGRE communication) appropriate tenants 122 in the appropriate VNet 118 for receiving the customer data to implement a control plane. The customer data is then sent to the appropriate VNet 118 and onto the appropriate tenants 122 within the appropriate VNet 118 using NVGRE.

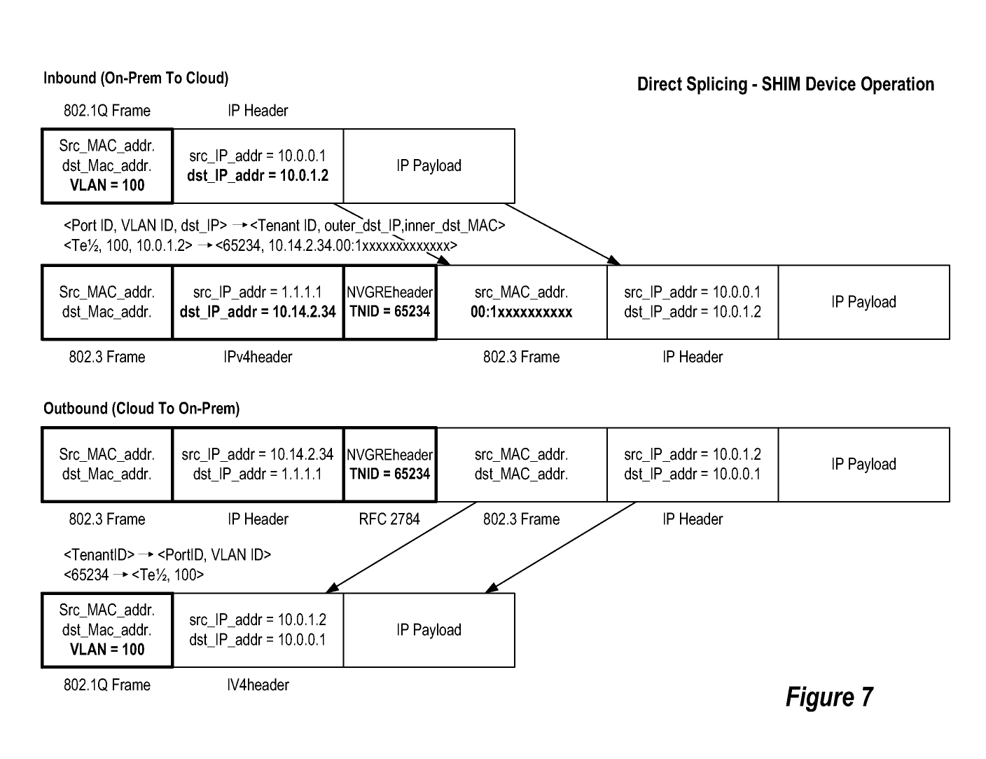

FIG. 7 depicts shim gateway operation for indirect splicing. As depicted in FIG. 7, for inbound communication a VLAN tag (VLAN=100) and destination IP address (10.0.1.2) is mapped to a Tenant ID (65234), a VNet (outer) IP address (10.14.2.34), and a tenant (inner) destination MAC address (00:1x:xx:xx:xx:xx). For outbound communication, a tenant ID (65234) is mapped to a VLAN tag (VLAN=100).

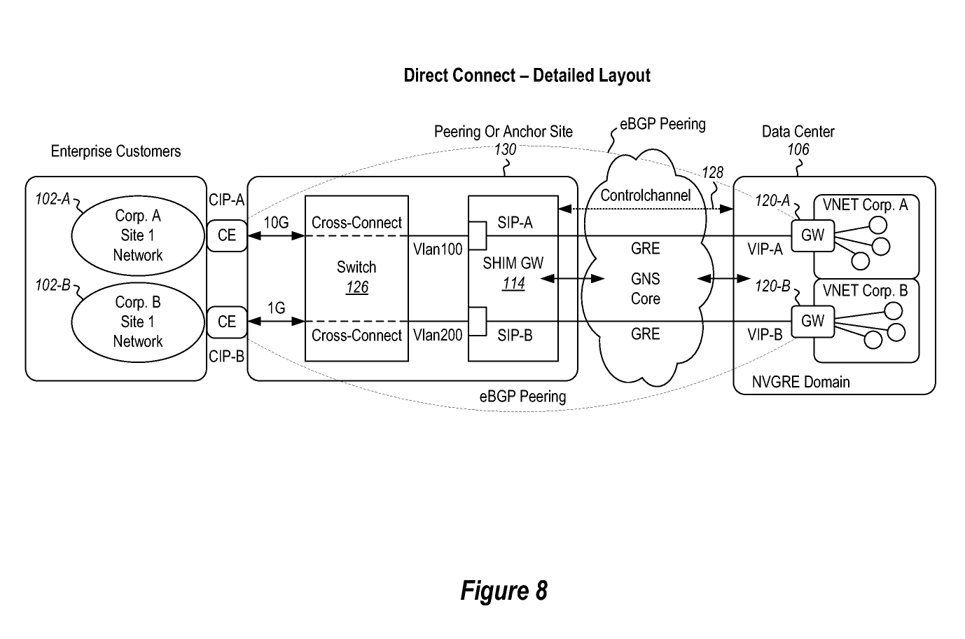

FIG. 8 depicts a more detailed layout for direction connection. In FIG. 8, various abbreviations are shown. The following summarizes those abbreviations:
CIP-A: Corporation A on-Premise Gateway
CIP-B: Corporation B on-Premise Gateway
SIP-A: GRE headend for Corporation A
SIP-B: GRE headend for Corporation B
VIP-A: Corporation A VNet Gateway
VIP-B: Corporation B VNet Gateway
CE: Customer edge router
GW: VNet Gateway

FIG. 8 illustrates that enterprise customers 102-A and 102-B have direct-access dedicated links from a switch 126. In the illustrated example, Corporation A gets a 10 G dedicated link, while Corporation B gets a 1 G dedicated link to the switch 126.

The switch performs a customer-circuit to VLan handoff (including tagging of the customer) to the shim gateway 114 installed at a peering or anchor site 126. In the illustrated example, the shim gateway 114 comprises a b 10/40 G switch. The shim gateway 114 takes VLan frames and maps (or encapsulates) them into the VNet domain using GRE. The shim gateway 114 could do direct NVGRE encapsulation if it can lookup Directory service for CA<>PA mapping (thereby bypassing the VNet-gateway in datapath)

While not shown in the illustrated example, the tenant gateways 120-A and 120-B on the data center 106 side, can be made multi-tenant. Further, the route exchange between on-premises systems (e.g. systems on Corporation A or Corporation B's site network) and cloud (e.g. the data center 106) could be done statically or using a BGP. FIG. 8 further illustrates that a control channel 128 from the data center 106 fabric to the shim-114 may be implemented to facilitate automated provisioning.

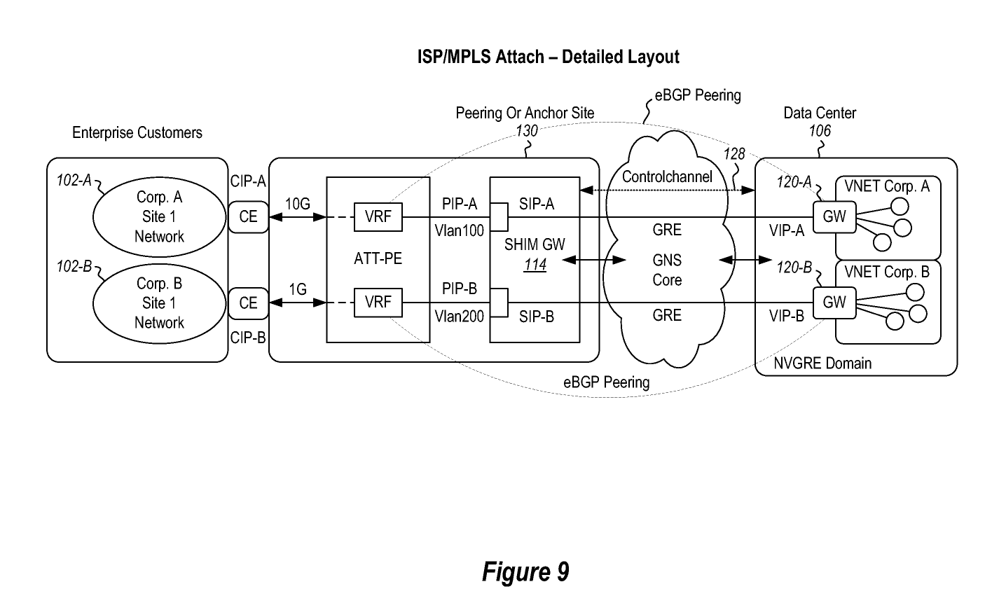

FIG. 9 depicts a more detailed layout for ISP/MPLS attach. FIG. 9 illustrates a number of abbreviations in addition to those shown in FIG. 8. Those additional abbreviations are summarized below:
PIP-A: Provider IP for Corporation A
PIP-B: Provider IP for Corporation B
PE: Provider Edge Router (e.g. ISP provider)

As illustrated in FIG. 9, enterprise customers 102-A and 102-B, peering with ISPs, can attach to the data center 106. The ISP does VRF to VLan handoff (including tagging of customers) to the shim gateway 114 installed at the switch provider site 130. The shim gateway 114 takes VLan frames and maps (or encapsulates) them into the VNet domain using GRE/NVGRE. The shim gateway 114 could do direct NVGRE encapsulation if it can lookup the data center directory service for CA <> PA mapping (thereby bypassing the VNet-gateway in the datapath). Tenant gateways 102-A and 102-B on the data center 106 side, can be made multi-tenant. Further, the route exchange between on-premises systems (e.g. systems on Corporation A or Corporation B's site network) and cloud (e.g. the data center 106) could be done statically or using a BGP. FIG. 9 further illustrates that a control channel 128 from the data center 106 fabric to the shim-114 may be implemented to facilitate automated provisioning.

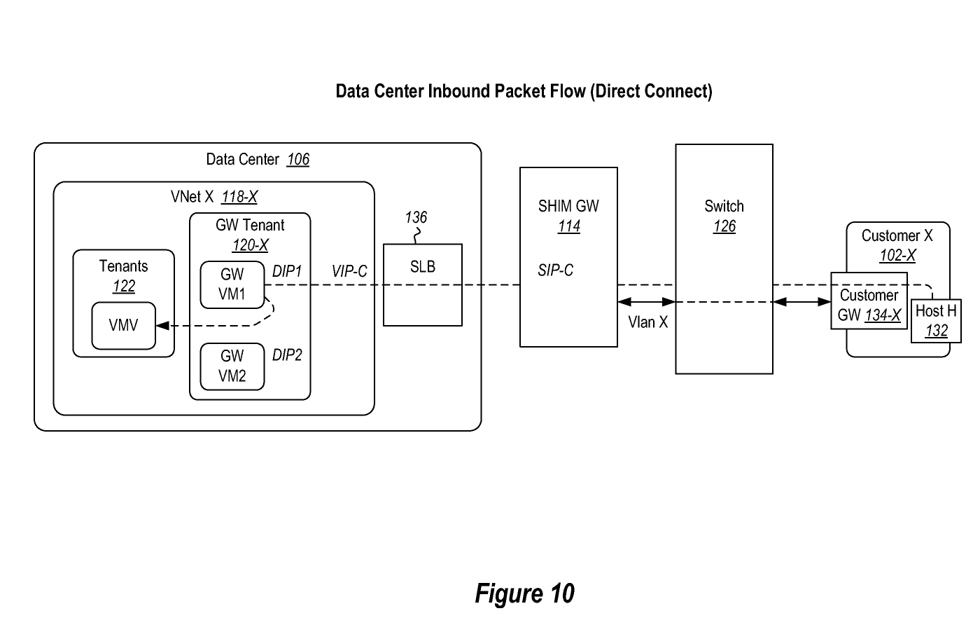

FIG. 10 depicts inbound packet flow to the data center for direct connect examples. FIG. 10 illustrates flow of packets from a host 132 at a customer site 102-X to tenants 122 at a VNet 118-X at a data center 106. Packets flow from the host 132 to a customer gateway 134-X. Encapsulation is performed at the customer gateway 134-X Packets are then sent to the switch 126. At the switch 126 VLan encapsulation is performed by the switch 126. Packets are then forwarded to the shim gateway 114. At the shim gateway 114, VLan decapsulation and GRE encapsulation are performed. Packets are then forwarded to a software load balancer (SLB) 136. As depicted in FIG. 10, an SLB 136 is used to balance loads between different virtual machines of a tenant gateway 120-X. At the SLB 136, SLB encapsulation is performed. Packets are then forwarded to a selected tenant gateway virtual machine. In the illustrated example, packets are forwarded to tenant gateway virtual machine 1. At the tenant gateway virtual machine, a software load balancer driver is used to perform software load balancer decapsulation and DNAT. Further, at the tenant gateway virtual machine, using a VNet driver, VNet decapsulation is performed. Further at the tenant gateway virtual machine, IP routing is performed to route the packets tenant virtual machine 1022. Further at the tenant gateway virtual machine, a VNet driver is used to perform VNet encapsulation. At the tenant virtual machine 1022, a VNet driver is used to perform VNet decapsulation.

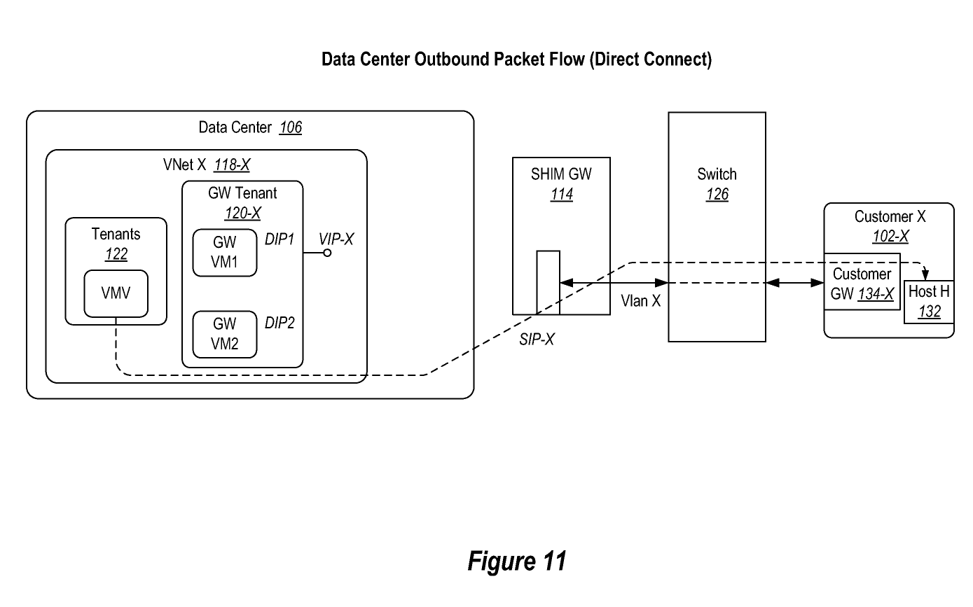

FIG. 11 depicts inbound packet flow for direct connect examples. FIG. 11 depicts that a packet originates at a source, which in this example is a tenant from a set of tenants 122 at the VNet 118-X of the data center 106. GRE encapsulation is performed using a VNet driver. The packet is sent to the shim gateway 114. At the shim gateway 114, GRE decapsulation is performed and VLan encapsulation is performed. The encapsulation is Ethernet with VLan encapsulation. The packet is then sent to the switch 126. At the switch 126 VLan decapsulation is performed and mapping to a customer port is performed. This allows the packet to be delivered to the host 132. As depicted in FIG. 11, outgoing communication bypasses the tenant gateway 120-X. b

VLAN to GRE lookup mapping can be performed in a variety of ways. To do VLAN to GRE lookup mapping:

(1) For Non OpenFlow switches
(a) Routed VPLS (IRB)—with L2 ports+VLans and L3 GRE tunnel interfaces; and
(b) VRF lite (L3 subinterface per VLAN and GRE tunnels in a VRF lite)

(2) For Open Flow Switches
(a) Install Match on Port+VLan=>result is VLan decapsulation and GRE encapsulation; and
(b) Install Match on GRE Dst-ip=?Result is GRE decapsulation and VLan encapsulation

(3) For S/W appliance—Using Vmswitch or OpenVswitch.

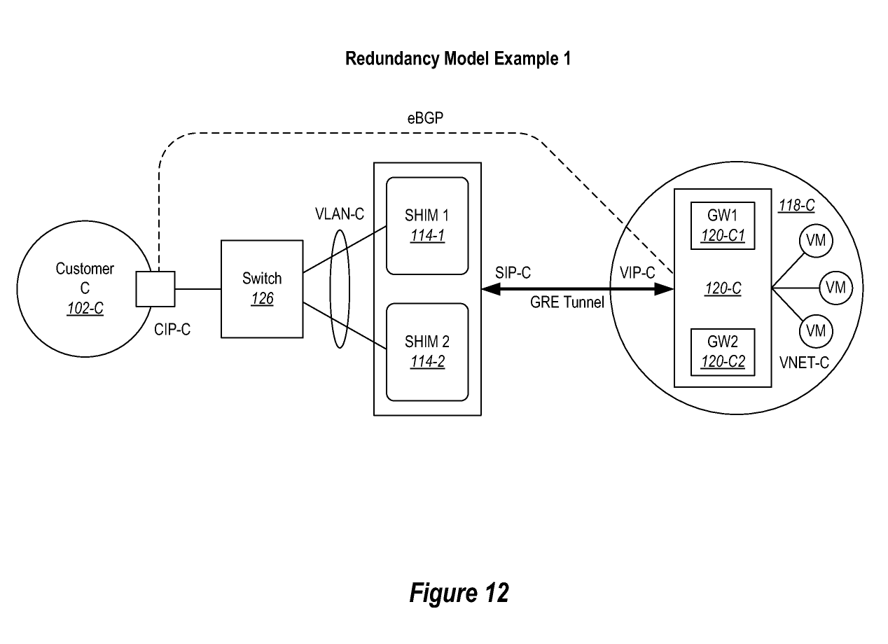

Embodiments of the invention include providing redundancy for customer connections to a cloud computing data center. FIG. 12 depicts a first example redundancy model. FIG. 12 illustrates one dedicated connection from the customer site 102-C using an eBGP session. FIG. 12 illustrates a cloud-connector. In the illustrated example, two devices, shim 114-1 and shim 114-2, act as one logical virtual PC (vPC) device. FIG. 12 further illustrates a tenant gateway 120-C. In the illustrated example, the load-balanced gateway 102-C is a multi-instance device including tenant gateway 120-C1 and tenant gateway 120-C2.

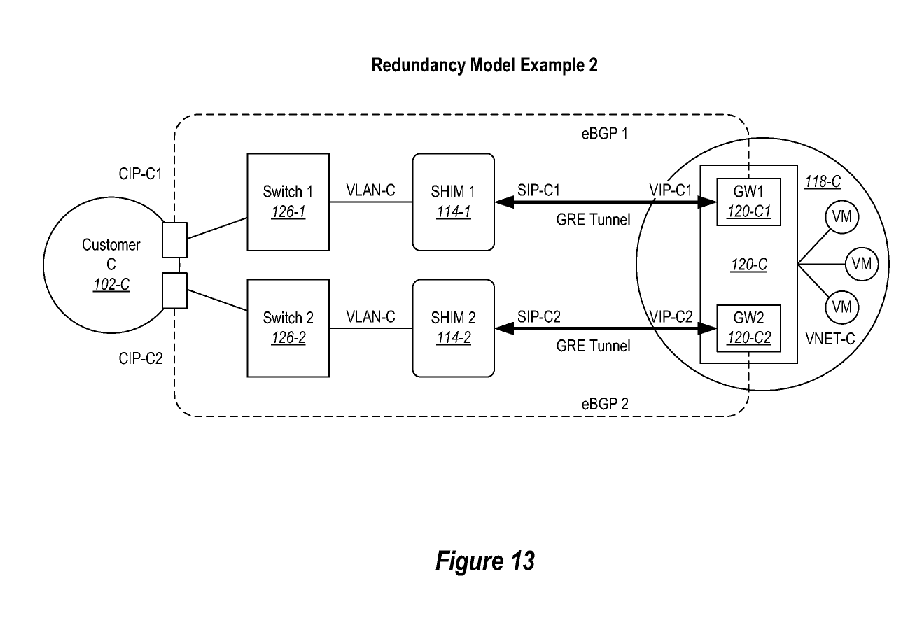

FIG. 13 depicts a second example redundancy model. FIG. 13 illustrates two dedicated connections from a customer site 102-C. In the illustrated example, two eBGP sessions are illustrated. FIG. 13 illustrates two separate switches 126-1 and 126-2 and two separate shim gateways 114-1 and 114-2. At the data center 106, the load-balanced gateway 102-C is a multi-instance device including tenant gateway 120-C1 and tenant gateway 120-C2.

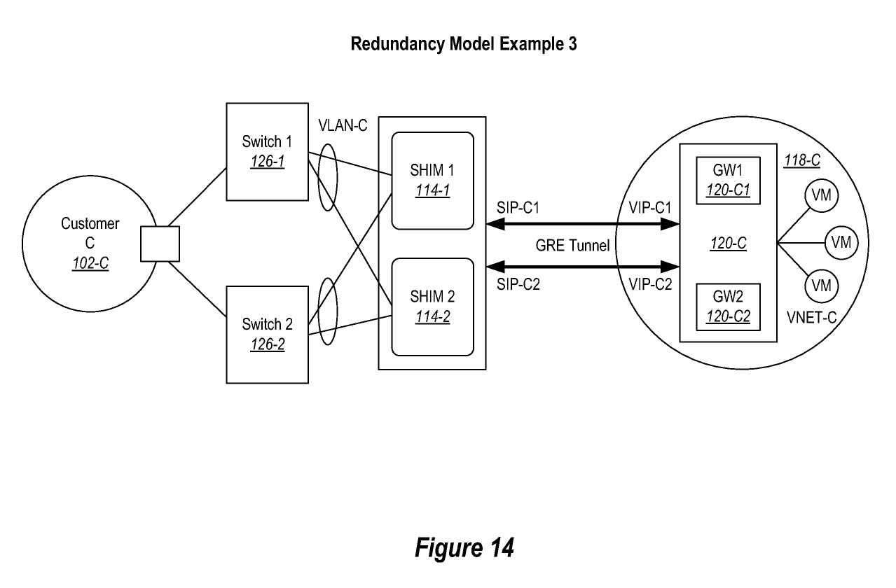

FIG. 14 depicts a third example redundancy model. FIG. 14 illustrates two separate switches 126-1 and 126-2 and two devices, shim 114-1 and shim 114-2, which act as one logical vPC device. FIG. 14 further illustrates a tenant gateway 120-C. In the illustrated example, the load-balanced gateway 102-C is a multi-instance device including tenant gateway 120-C1 and tenant gateway 120-C2.

Accordingly, embodiments of the invention provide increased scalability. The capacity of a gateway can be increased by adding more virtual machines running the connectivity service. Gateways can be integrated with an existing network load-balancer and hence inherits the corresponding benefits, such as resource pooling and high availability. Cross premise connectivity is supported via various access modes customers choose, including MPLS and direct circuit.

Embodiments permit multiple customers/tenants to connect to a public cloud using scalable gateway front end and multi-tenant back-end infrastructure. Dynamic routing, failover and resiliency are provided by leveraging BGP. Embodiments of the invention work at layer-2 and hence do not depend on IP routing or VRF (Virtual Routing and Forwarding) technology, lowering complexity significantly.

Accordingly, embodiments of the invention include using any of the described indirect and direct splicing mechanisms with (1) multiple access modes, (2) multi-tenancy using L2 to L3 interconnection (and independent of other mechanisms, such as, VRF), (3) scaling-out and high availability facilitated by load balancing technology, and (4) support for NVGRE.

Embodiments of the invention enable high-speed cross-premise (e.g., customer site to virtual network) interconnection scenarios.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

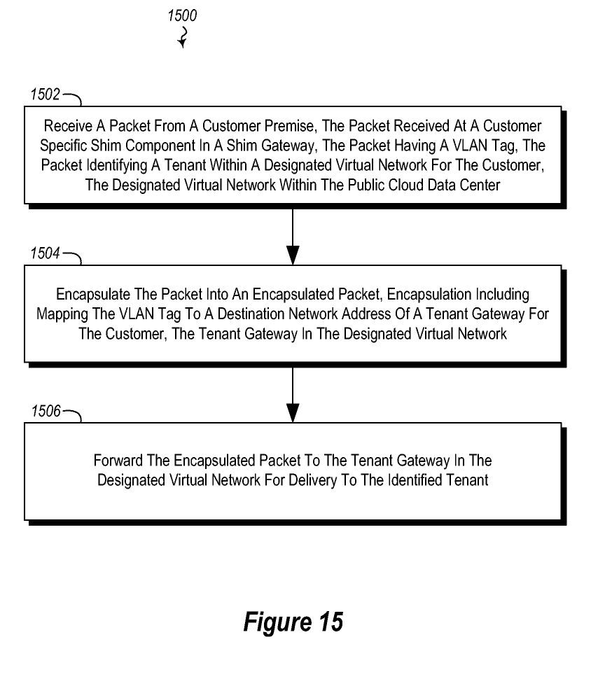

Referring now to FIG. 15, a method 1500 is illustrated. The method 1500 may be practiced at a computer system including one or more processors and system memory. The computer system includes a shim gateway. The method includes acts for encapsulating a packet between a customer premise, such as customer premise 102, for delivery to customer resources within a public cloud data center, such as data center 106. The method includes an act of receiving a packet from a customer premise (act 1502). The packet is received at a customer specific shim component in the shim gateway, such as for example, a shim component 116. The packet having a VLAN tag, such as the VLAN tags illustrated in FIGS. 5 and 7. The packet identifies a tenant (e.g. from among tenants 122) within a designated virtual network (e.g. virtual network 118) for the customer. The designated virtual network is within the public cloud data center.

The method 1500 further includes an act of encapsulating the packet into an encapsulated packet (act 1502). Encapsulation includes mapping the VLAN tag to a destination network address of a tenant gateway for the customer, where the tenant gateway is in the designated virtual network. Examples of tenant gateways are illustrated 120 for individual gateways where each gateway is particular to a particular VNet or at 124 where a multi-tenant gateway is used for a plurality of different VNets.

The method 1500 further includes an act of forwarding the encapsulated packet to the tenant gateway in the designated virtual network for delivery to the identified tenant.

The method 1500 may be practiced where the act of receiving a packet from a customer premise comprises an act of receiving a packet via one of a plurality of access modes supported by the shim gateway.

The method 1500 may be practiced where the act of encapsulating the packet into an encapsulated packet comprises an act of encapsulating the packet into an encapsulated packet. For example, as illustrated above, encapsulation may be accomplished using GRE or NVGRE.

The method 1500 may be practiced where the tenant gateway is a multi-tenant gateway (such as is illustrated at 124). In such embodiments, the act of encapsulating the packet into an encapsulated packet comprises an act of encapsulating the packet into an encapsulated packet where encapsulation includes mapping the VLAN tag to a destination network address of a multi-tenant gateway. The multi-tenant gateway is in the public cloud data center. The multi-tenant gateway is a gateway for a plurality of different virtual networks, including the designated virtual network. The an act of forwarding the encapsulated packet to the tenant gateway in the designated virtual network for delivery to the identified tenant includes act of an act of forwarding the encapsulated packet to the multi-tenant gateway for delivery to the identified tenant.

The method 1500 may be practiced where communication is facilitated by a high-speed cross premise interconnection.

The method 1500 may be practiced where the act of forwarding the encapsulated packet to the tenant gateway in the designated virtual network for delivery to the identified tenant comprises forwarding the packet to a software load balancer to forward the encapsulated packet to a virtual machine selected from a plurality of virtual machines at the tenant gateway. For example, FIG. 10 illustrates the use of a software load balancer 136.

The method 1500 may be practiced where the act of encapsulating the packet into an encapsulated packet includes mapping the VLAN tag and a destination address in the packet to a Tenant ID, an electronic address for the designated virtual network, and an electronic address for the tenant

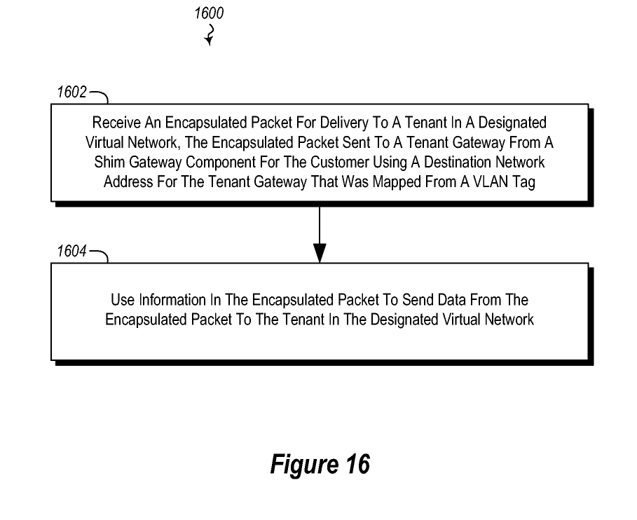

Referring now to FIG. 16, a method 1600 is illustrated. The method 1600 may be practiced in a computer system including one or more processors and system memory. The computer system including a tenant gateway (such as tenant gateway 120 or multi-tenant gateway 124). The method includes acts for delivery of an encapsulated packet between a customer premise for delivery to customer resources within a public cloud data center (for example, delivery of packets from a customer premise 102 to resources at tenants 122 in a data center 106). The method 1600 includes an act of the tenant gateway receiving an encapsulated packet for delivery to a tenant in a designated virtual network (act 1602). The encapsulated packet is sent to the tenant gateway from a shim gateway component for the customer using a destination network address for the tenant gateway that was mapped from a VLAN tag.

The method 1600 further includes an act of the tenant gateway using information in the encapsulated packet to send data from the encapsulated packet to the tenant in the designated virtual network (act 1604).

The method 1600 may further include a load balancer determining to send the encapsulated packet to an instance of a virtual machine to load balance packets coming into the designated virtual network.

The method 1600 may be practiced where the act of the tenant gateway receiving an encapsulated packet for delivery to a tenant comprises an act of the tenant gateway receiving a GRE packet or an NVGRE patent.

The method 1600 may be practiced where the act of the tenant gateway using information in the encapsulated packet to send data from the encapsulated packet to the tenant in the designated virtual network comprises an act of converting a GRE packet to an NVGRE packet.

The method 1600 may be practiced where the tenant gateway is a multi-tenant gateway. The multi-tenant gateway is a gateway for multiple virtual networks. In such embodiments, the act of the tenant gateway receiving an encapsulated packet for delivery to a tenant in a designated virtual network comprises an act of the multi-tenant gateway receiving an encapsulated packet for delivery to a tenant in a designated virtual network from among the multiple virtual networks. The encapsulated packet is sent to the multi-tenant gateway using a destination network address for the multi-tenant gateway that was mapped from the VLAN tag. Such embodiments may further comprise an act of the multi-tenant gateway using information in the encapsulated packet to identify the designated virtual network. Such embodiments may further comprise an act of the multi-tenant gateway sending data from the encapsulated packet to the tenant in the designated virtual network.

The method 1600 may be practiced where the tenant gateway corresponds to a single designated virtual network.

The method 1600 may be practiced where communication is facilitated by a high-speed cross premise interconnection.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. At a computer system including one or more processors and system memory, the computer system including a shim gateway, a method for encapsulating a packet between a customer premise for delivery to customer resources within a public cloud data center, the method comprising:
an act of receiving a packet from a customer premise, the packet received at a customer specific shim component in the shim gateway, the packet having a VLAN tag, the packet identifying a tenant within a designated virtual network for the customer, the designated virtual network within the public cloud data center;
an act of encapsulating the packet into an encapsulated packet, encapsulation including mapping the VLAN tag to a destination network address of a tenant gateway for the customer, the tenant gateway in the designated virtual network; and
an act of forwarding the encapsulated packet to the tenant gateway in the designated virtual network for delivery to the identified tenant.

2. The method as recited in claim 1, wherein the act of receiving a packet from a customer premise comprises an act of receiving a packet via one of a plurality of access modes supported by the shim gateway.

3. The method as recited in claim 1, wherein the act of encapsulating the packet into an encapsulated packet comprises an act of encapsulating the packet into an encapsulated packet using GRE or NVGRE.

4. The method as recited in claim 1, wherein the tenant gateway is a multi-tenant gateway, and wherein the act of encapsulating the packet into an encapsulated packet, encapsulation including mapping the VLAN tag to a destination network address of a tenant gateway for the customer comprises an act of encapsulating the packet into an encapsulated packet, encapsulation including mapping the VLAN tag to a destination network address of a multi-tenant gateway, the multi-tenant gateway in the public cloud data center, the multi-tenant gateway being a gateway for a plurality of different virtual networks, including the designated virtual network; and wherein the an act of forwarding the encapsulated packet to the tenant gateway in the designated virtual network for delivery to the identified tenant comprises act of an act of forwarding the encapsulated packet to the multi-tenant gateway for delivery to the identified tenant.

5. The method as recited in claim 1, wherein communication is facilitated by a high-speed cross premise interconnection.

6. The method as recited in claim 1, wherein the act of forwarding the encapsulated packet to the tenant gateway in the designated virtual network for delivery to the identified tenant comprises forwarding the packet to a software load balancer to forward the encapsulated packet to a virtual machine selected from a plurality of virtual machines at the tenant gateway.

7. The method as recited in claim 1, wherein the act of encapsulating the packet into an encapsulated packet includes mapping the VLAN tag and a destination address in the packet to a Tenant ID, an electronic address for the designated virtual network, and an electronic address for the tenant

8. At a computer system including one or more processors and system memory, the computer system including a tenant gateway, a method for delivery of an encapsulated packet between a customer premise for delivery to customer resources within a public cloud data center, the method comprising:
an act of the tenant gateway receiving an encapsulated packet for delivery to a tenant in a designated virtual network, the encapsulated packet sent to the tenant gateway from a shim gateway component for the customer using a destination network address for the tenant gateway that was mapped from a VLAN tag; and
an act of the tenant gateway using information in the encapsulated packet to send data from the encapsulated packet to the tenant in the designated virtual network.

9. The method as recited in claim 8, further comprising a load balancer determining to send the encapsulated packet to an instance of a virtual machine to load balance packets coming into the designated virtual network.

10. The method as recited in claim 8, wherein the act of the tenant gateway receiving an encapsulated packet for delivery to a tenant comprises an act of the tenant gateway receiving a GRE packet or an NVGRE patent.

11. The method as recited in claim 8, wherein the act of the tenant gateway using information in the encapsulated packet to send data from the encapsulated packet to the tenant in the designated virtual network comprises an act of converting a GRE packet to an NVGRE packet.

12. The method as recited in claim 8, wherein the tenant gateway is a multi-tenant gateway, the multi-tenant gateway being a gateway for multiple virtual networks, and:
wherein the act of the tenant gateway receiving an encapsulated packet for delivery to a tenant in a designated virtual network comprises an act of the multi-tenant gateway receiving an encapsulated packet for delivery to a tenant in a designated virtual network from among the multiple virtual networks, the encapsulated packet sent to the multi-tenant gateway using a destination network address for the multi-tenant gateway that was mapped from the VLAN tag;
further comprising an act of the multi-tenant gateway using information in the encapsulated packet to identify the designated virtual network; and
further comprising an act of the multi-tenant gateway sending data from the encapsulated packet to the tenant in the designated virtual network.

13. The method as recited in claim 8, wherein the tenant gateway corresponds to a single designated virtual network.

14. The method as recited in claim 8, wherein communication is facilitated by a high-speed cross premise interconnection.

15. A computer system for encapsulating a packet between a customer premise for delivery to customer resources within a public cloud data center, the computer system comprising:
a shim gateway, wherein the shim gateway comprises a plurality of customer specific shim components, wherein each of the customer specific shim components are configured to:
receive a packet from a customer premise, the packet having a VLAN tag, the packet identifying a tenant within a designated virtual network for the customer, the designated virtual network within the public cloud data center;
encapsulate the packet into an encapsulated packet, encapsulation including mapping the VLAN tag to a destination network address of a tenant gateway for the customer, the tenant gateway in the designated virtual network; and
forward the encapsulated packet to the tenant gateway in the designated virtual network for delivery to the identified tenant.

16. The computer system of claim 15, wherein the shim gateway is configured to communicate with individual tenant gateways, where each of the individual tenant gateways corresponds to a particular virtual network.

17. The computer system of claim 15, wherein the shim gateway is configured to communicate with a multi-tenant gateway tenants, where the multi-tenant gateway is configured to connect to a plurality of virtual networks.

18. The computer system of claim 15, wherein the shim gateway comprises a plurality of shim devices acting together as a single logical vPC device.

19. The computer system of claim 15, wherein the shim gateway comprises a plurality of shim devices distributed among different dedicated sessions between a customer premise and the public cloud data center.

20. The computer system of claim 15, wherein the shim gateway comprises a plurality of redundant shim devices.
